(19) United States
(12) Patent Application Publication
(10) Pub. No.: US 2018/0325278 A1
(43) Pub. Date: Nov. 15, 2018

(54) REST SUPPORT WITH COMFORT EFFECT

(71) Applicant: A. MOLINA & C. S.P.A., CAIRATE (Varese) (IT)

(72) Inventor: Agostino MOLINA, CAIRATE (Varese) (IT)

(73) Assignee: A. MOLINA & C. S.P.A., CAIRATE (Varese) (IT)

(21) Appl. No.: 15/978,605

(22) Filed: May 14, 2018

(30) Foreign Application Priority Data
May 15, 2017 (IT) 202017000052526

(51) Int. Cl. A47C 27/12; B32B 7/02; A47C 17/86

(52) U.S. Cl. CPC A47C 27/121; B32B 7/02; B32B 2479/00; A47C 27/124; A47C 17/86

(57) ABSTRACT

A rest support with comfort effect is provided including a first layer, a second layer and a third layer. The second layer may be between the first layer and the third layer. The first and third layer may be composed of a lesser stiffness than the second layer and at least one out of the first and third layer includes a cohesive stratum made by thermo-moulding with a material, such as down, feathers, chips, flakes, fibres and the like.

### TECHNICAL BACKGROUND OF THE INVENTION

The present invention relates to a rest support with comfort effect comprising: a first layer, a second layer, a third layer, the second layer being between the first layer and the third layer.

### DESCRIPTION OF THE PRIOR ART

In particular, the present invention relates to a support which ensures the support of a user, such as a mattress, a cushion or backrest, seat or mattress topper namely a particular device, commercially known by the name Topper, capable of being associated with the mattress so as to lie between it and the user increasing the feeling of comfort during sleep or partially changing the properties of the mattress itself, or other rest support containing a padding material.

As known, mattresses, sofas or other rest supports constituting furnishings and used, for example, to seat a user and/or allow him/her to lie down, as well as seats, armchairs, benches, bunks, camp beds, beds and all other components of land, sea/submarine and aerospace craft used for such purpose, consist of padding elements or cushions or otherwise, alternately or additionally, covered with toppers and all suitable to increase the comfort of said supports and components.

In the specific case of mattresses, a plurality of products are available on the market.

For example, spring, pocket sprung, latex, polyurethane foam or compound mattresses are known of.

Spring mattresses are probably the most common type among those listed above, in the European market, with a plurality of different layers including lining, padding, insulation and cushioning.

In addition, these objects include a layer comprising a plurality of springs, generally hourglass-shaped, cooperating and generally designed to absorb the deformations caused by the interaction between the mattress and a user.

Pocket sprung mattresses are similar to the previous but have linear springs individually wrapped in single fabric pockets. Thanks to the freedom of movement of independent springs, a balanced distribution of loads and harmonic support without pressure points on the spine is achieved.

The support thus adapts to the body shape, and also reduces the transmission of movements from one user to another.

Latex mattresses are composed of an inner intermediate layer of latex. This layer receives the user's body without generating pressures and is ideal for those who prefer mattresses with a high elasticity and resilience: the latex harmoniously supports various degrees of pressure generated by the weight of the body, immediately compensating any variation.

Polyurethane foam mattresses comprise polymer inside them in the form of foam. These may comprise, in particular those comprising visco-elastic, or slow return polyurethane (known as memory foam), which has the ability to mould perfectly to the body shape and distribute the weight evenly, thereby reducing the pressure points, returning then to its original form.

In conclusion, compound materials may comprise two or more of the technical details described above for the various types of mattress.

Coming now to the topper, as known, the purpose of such mattress topper is generally to increase the degree of comfort of the mattress, improving the distribution of body weight, thus avoiding the formation of harmful pressure points.

The mattress toppers currently used generally comprise a lining, inside which a sheet a few centimetres thick is placed and usually made of possible different materials such as: down, elastic polymers, gel-based mixtures, latex foams, and so forth.

As regards, lastly, the cushions of the backrests/seats, construction techniques may be the same as those of mattresses, or may be simplified, consisting of a protective cover, such as polyester batting, comprising an interior composed of foam rubber or polyurethane foam chips, flakes, fibres or other similar materials.

In addition, the cushions of the backrests and/or seats may comprise characteristics similar to those mentioned above, with the difference of presenting, something also possible for the topper, internal quilting suitable to divide the surfaces of the cushions and the said toppers into dimensionally reduced and mutually independent areas, also called pockets.

The prior art described has several significant drawbacks.

In particular, mainly with reference to mattresses, these normally have a plurality of layers in different materials, as seen with different functions; more frequently, at least one or a few used for support, and one or other instead to give greater comfort, although various further functions of said layers are also possible, for example orthopaedic, massaging, insulating, disinfectant, allergenic or hypo-allergenic, mite and insect repellent and so forth.

The current shape of the layers used to give greater comfort, however, in order to achieve certain benefits, requires the use of expensive materials and where cheaper, employs non-natural and non-eco-friendly materials.

As for the cushions of the backrests, seats or mattress toppers, for which the significant drawbacks outlined above for mattresses may also present themselves, the materials used in the layers used to give greater comfort require in most cases further processing such as quilting, blowing in the pockets obtained by such quilting, injection into containment cages or moulds and/or otherwise, which increases the complexity of the support devices in question and their production costs, requiring time consuming and labour intensive activities by skilled workers, often with craft skills, as well as special machines to carry them out.

In addition to the other consequences of the current state of the art listed above, in the case of backrest and seat cushions covered with an outer cover in leather, eco-leather or similar materials, as frequently happens with such products, and with inner layers of padding, designed to increase comfort, quilted or, worse still, filled with movable padding in chips, flakes, fibres and the like, not appropriately bonded, in the absence of quilting, there may also be a “cellulite” or “orange peel” effect.

This effect of this over time is to create on the outer cover in question, if placed in contact with the inner layers used to give more comfort to the same, wrinkles and creases, recalling the effect created on human skin by the said condition, created on the covering materials as a result of the uneven distribution of the internal padding, or air spaces physiologically created inside the same in the cases in question, on account of the irregular and uneven shape and distribution which if not properly bonded creates voids in the bottom layer. Over time such voids create, when the user sits down and forces the air out of the seat or the backrest, the aforesaid aesthetically unpleasant result, giving the appearance of ageing.

### SUMMARY OF THE INVENTION

In this situation, the technical purpose of the present invention is to devise a rest support with comfort effect able to substantially overcome at least some of the drawbacks mentioned.

Within the sphere of said technical purpose one important aim of the invention is to obtain a rest support to seat the user and/or allow him to lie down having a different conformation compared to that constructed in the current state of the art, such as to use to the same effect, padding materials, in the layer designed to give greater comfort, which are more economical, natural and/or more environmentally friendly.

Another important purpose of the invention is to achieve a less complex structure compared to the prior art, of the rest support in question, in the case of the backrest and seat and topper cushions, regardless of the padding material used in the layer used to give greater comfort; a structure which, therefore, even using in said layer padding materials which would require instead further processing (such as quilting and the consequent blowing, pocket by pocket) in order to resolve the typical distribution and concentration problems of the same, makes it possible to preserve the main characteristics of such materials, while also obviating the typical problems of distribution and concentration identified above, but with significantly lower production costs due to the simplification of the structure itself and, consequently, its manufacturing process.

In conclusion, another purpose of the invention is to make a rest support such as that described above, in the case of backrest and seat cushions covered with an outer cover in leather, eco-leather or similar materials, which has inner layers of padding used to provide greater comfort, quilted or filled with movable padding in chips, flakes, fibres and the like, not appropriately bonded, in the absence of quilting, which also eliminates the conventional drawback thereof of the “cellulite” and “orange peel” effect as further described above.

The technical purpose and specified aims are achieved by a rest support with comfort effect comprising: a first layer, a second layer, a third layer, the second layer being comprised between the first layer and the third layer, the first and third layer being composed of a lesser stiffness than the second layer, at least one between the first and third layer comprising a cohesive stratum made by thermo-moulding, the cohesive stratum including a material as wished chosen from between down, feathers, chips, flakes, fibres and the like.

### BRIEF DESCRIPTION OF THE DRAWINGS

The characteristics and advantages of the invention are clearly evident from the following detailed description of preferred embodiments thereof, with reference to the accompanying drawings, in which:

FIG. 1 is a first rest support with comfort effect in a configuration as backrest and seat cushions of a sofa according to the invention;

FIG. 2 shows a second rest support with comfort effect in a mattress topper configuration according to the invention; and

FIG. 3 shows a third rest support with comfort effect in a mattress configuration according to the invention.

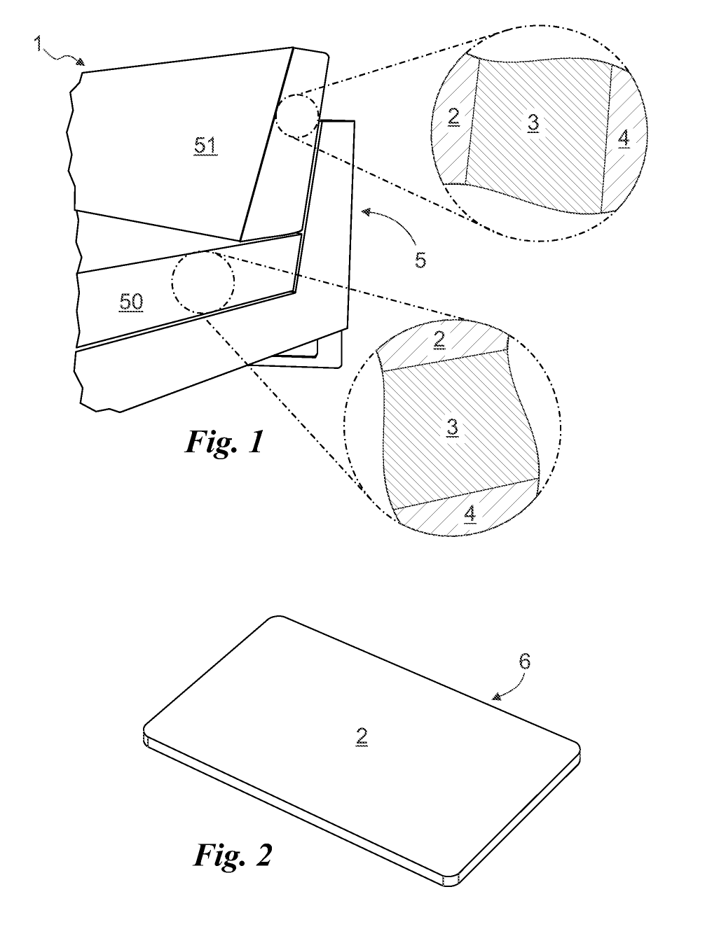

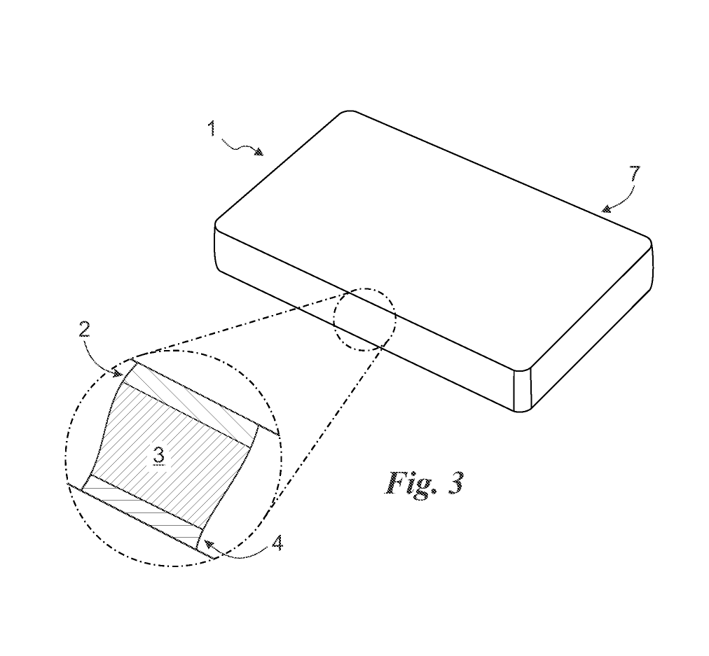

### DESCRIPTION OF THE PREFERRED EMBODIMENTS

Herein, the measures, values, shapes and geometric references (such as perpendicularity and parallelism), when used with words like “about” or other similar terms such as “approximately” or “substantially”, are to be understood as except for measurement errors or inaccuracies due to production and/or manufacturing errors and, above all, except for a slight divergence from the value, measure, shape or geometric reference which it is associated with. For example, said terms, if associated with a value, preferably indicate a divergence of not more than 10% of said value.

In addition, where used terms such as “first”, “second”, “upper”, “lower”, “main” and “secondary” do not necessarily refer to an order, a priority relationship or relative position, but may simply be used to more clearly distinguish different components from each other.

The measurements and data presented herein are to be considered, unless otherwise indicated, as made in Standard International Atmospheres ICAO (ISO 2533).

With reference to the Drawings, reference numeral 1 globally denotes the rest support with comfort effect according to the invention.

The support 1, in general, is suitable to allow the support of a user in such a way as to support the same in sitting and/or lying down, and therefore, preferably, may be an object chosen between a sofa 5, an armchair, or other furnishings or components of means of transport equipped, like a sofa, with backrest and seat cushions provided for such purpose, a topper 6 and a mattress 7.

The sofa 5 has a seat 50 and a backrest 51.

The seat 50 is the support part on which the user completely offloads his weight, while the backrest 51 is the part suitable to support the user's back.

The topper 6 and mattress 7 instead have a single portion, structurally undivided.

The support 1 preferably comprises a first layer 2, a second layer 3 and a third layer 4. But it may also comprise only a first layer 2, as most frequently, but not exclusively, takes place in the topper configuration 6 of said support 1.

Preferably, the second layer 3 is between the first layer 2 and the third layer 4.

In particular, preferably, the first and third layer 2, 4, preferably with comfort functions, consist of a lesser stiffness than the second layer 3, preferably with support functions.

The first and third layers 2, 4 therefore preferably comprise a cohesive stratum.

This cohesive stratum preferably comprises material in chips, flakes, fibres and the like, and is made, more preferably by means of a thermo-fusion, low melt process.

This procedure is generally obtained by means of bi-component or polyethylene/polyester polyester binding materials (COPET/PET or PE/PET), but also others.

The cohesive stratum is preferably further processed with an air laid technology.

The air laid technology provides, for example, for laying the materials of the cohesive stratum onto suction roller belts and, in detail, comprising a material chosen from among down, feathers or other materials in chips, flakes, fibres and the like, such as wool, cashmere, Tencel, kapok, polyester, polyamide and miscellaneous mixtures thereof, made in the following ranges of thickness from 5 mm to 15 cm and weight relative to the surface from 3 dag/m² to 1 kg/m².

Both the down and the feathers and other materials in chips, flakes, fibres and the like mentioned above can be refined material, more or less noble, or waste material, and are intended to be transformed into a cohesive stratum in the first and third layers 2, 4, so as to achieve a stiffness less than the layer 3, and suitable to fulfil its main function of conferring comfort for a user.

In the case in which the support 1 is a sofa 5, the layers 2, 3, 4 are comprised within at least one, as desired, out of the seat 50 and the backrest 51 of the sofa 5. Preferably, therefore, at least one out of the first and third layers 2, 4 constitutes a padding portion, with a main comfort function, for at least one chosen as desired out of the seat 50 and backrest 51.

In the case in which the support 1 is composed instead of a topper 6 or a mattress 7, at least one out of the first and third layers 2, 4 defines the padding portion of the mattress 6.

In an alternative configuration to those described, preferably with three layers and, in the case of topper, more frequently, but not exclusively, a single layer, the third layer 4, may lastly possibly have the same characteristics as the second layer 3, or be completely absent.

In this case, the layer 3 comprises materials known to the current state of the art.

The rest support with comfort effect 1 according to the invention achieves important advantages.

In fact, the invention allows the creation of supports 1 suitable to overcome the drawbacks of the known art and, in particular, makes it possible to obtain a rest support with a conformation such as to allow the use, for the same effect, of more economical, natural and more environmentally friendly padding materials, in the layer used to give greater comfort.

In addition, the support 1 allows the creation of a less complex structure, compared to the prior art, of the rest support, especially in the case of the cushions of the backrests, seats and toppers.

Regardless of the padding material used, in the current state of the art in the layer used to give greater comfort; the support structure 1 uses, in said layer, padding materials, which would instead require subsequent processing steps so as to solve the problems of distribution and concentration typical thereof, makes it possible to maintain the main characteristics of said materials with significantly lower production costs, due to the simplification of the structure itself and, consequently, of its manufacturing process.

In the case of backrest and seat cushions covered with an outer cover in leather, eco-leather or similar materials, which has inner layers of padding used to provide greater comfort, quilted or even worse, filled with movable padding in chips, flakes, fibres and the like, not appropriately bonded, in the absence therefore of quilting, the support 1 makes it possible to eliminate the conventional drawback of the same of the “cellulite” and “orange peel” effect. Variations may be made to the invention described herein without departing from the scope of the inventive concept defined in the claims.

In said sphere all the details may be replaced with equivalent elements and the materials, shapes and dimensions may be as desired.

1. A rest support with comfort effect comprising:
a first layer,
a second layer,
a third layer,
said second layer being comprised between said first layer and said third layer,
said first and third layers being composed of a lesser stiffness than said second layer,
at least one of said first and third layers comprising a cohesive stratum made by thermo-fusion,
said cohesive stratum including material as chosen from down, feathers, chips, flakes, fibres and the like.

2. The support according to claim 1, consisting of a sofa wherein said layers are included inside at least one element chosen from between a seat and a backrest of said sofa.

3. The support according to claim 1, consisting of a topper comprising at least one of said first and third layers.

4. The support according to claim 1, consisting of a mattress, wherein said layers are all included inside the single portion, structurally undivided.

5. The support according to claim 1, wherein the third layer has the same characteristics as the second layer.

6. The support according to claim 1, wherein said cohesive stratum is made by means of binding materials chosen from among bi-component polyester or polyethylene/polyester.

7. The support according to claim 1, wherein said cohesive stratum is processed with air laid technology.

8. The support according to claim 1, wherein said cohesive stratum has a thickness of between 3 mm and 15 cm.

9. The support according to claim 1, wherein said cohesive stratum has a weight relative to the surface ranging from 3 dag/m² to 1 kg/m².
